(19) United States
(12) Patent Application Publication
(10) Pub. No.: US 2022/0044082 A1
(43) Pub. Date: Feb. 10, 2022

(54) PRINTER CALIBRATION UTILIZING NON-PRODUCTION FRAMES

(71) Applicant: Hewlett-Packard Development Company, L.P., Spring, TX (US)

(72) Inventors: Shane Shivji, Corvallis, OR (US); Thomas J. Peck, Corvallis, OR (US)

(73) Assignee: Hewlett-Packard Development Company, L.P., Spring, TX (US)

(21) Appl. No.: 17/298,488

(22) PCT Filed: Apr. 30, 2019
(86) PCT No.: PCT/US2019/029828

§ 371 Date: May 28, 2021

(51) Int. Cl. G06K 15/02; B41J 2/21; G06K 15/00

(52) U.S. Cl. CPC G06K 15/027; G06K 15/408; G06K 15/022; B41J 2/2142

(57) ABSTRACT

In an example of the disclosure, a print job is received. The print job is to be printed upon a roll media at a printer, and includes a set of production frames 1-n. Printing of the production frames, a non-production frame x and a non-production frame y is caused. The non-production frame x includes an instruction to modify a non-printing apparatus that is to perform an action upon the printed print job, and is printed after the printing of production frame 1 and before the printing of production frame n. The non-production frame y includes a diagnostic and is printed after the printing of production frame 1 and before the printing of production frame n. The diagnostic is scanned to generate scan data. The scan data utilized to perform a calibration operation at the printer.

### BACKGROUND

A printer may apply marking agents to a paper or another media to produce an image upon the media. One example of printer is a web-fed printer device, wherein during production printing marking agent application components apply the marking agents to a web media fed to the printer device by a web supply reel. Following the application of the marking agents, the web media may be collected on a take-up drum or cut into sheets by an apparatus that is in-line with the printer. In certain examples, the print application components may apply the marking agent via inkjet (e.g., thermal inkjet or piezo inkjet) or dry toner printing technologies. In other examples, the print application components may apply to the media an electrostatic printing fluid (e.g., electrostatically chargeable toner or resin colorant particles dispersed or suspended in a carrier fluid).

### DRAWINGS

FIG. 1 is a block diagram depicting an example of a system for printer calibration utilizing non-production frames.

FIG. 2 is a block diagram depicting another example of a system for printer calibration utilizing non-production frames.

FIG. 3 is a block diagram depicting a memory resource and a processing resource to implement an example of a method for printer calibration utilizing non-production frames.

FIGS. 4A-4F are simple schematic diagrams that illustrate examples of a system for printer calibration utilizing non-production frames.

FIGS. 5A-5C are simple schematic diagrams that illustrate examples of a non-production frame having an instruction for modification of a non-printing apparatus.

FIGS. 6A-6C are simple schematic diagrams that illustrate examples of non-production frames having a diagnostic, the diagnostic scannable to generate scan data for use in a printer calibration operation.

FIG. 7 is a flow diagram depicting an example implementation of a method for printer calibration utilizing non-production frames.

### DETAILED DESCRIPTION

Current systems for web media printing typically perform a number of calibration processes and set up post-print processing (e.g., finishing operations) during pauses in marking agent application operations. The calibration processes are to ensure the images to be printed are printed with the desired alignment and the desired color densities. For instance, a digital printing device may undergo image registration and color accuracy calibration routines at the beginning of a print job, in response to identification of a printer component error, or as part of a web media roll change procedure. The setup operations are to enable a downstream non-printing apparatus to perform the post-print processing upon the printed job. In examples of current systems, printing is often paused to accomplish the printer calibrations and/or the setup of the downstream non-printing apparatus. Stoppages of the roll media for calibration and post-processing setup can significantly add to the time required for completing a production print job.

To address these issues, various examples described in more detail below provide a system and a method for printer calibration utilizing non-production frames. In examples of the disclosure, rather than pausing marking agent application operations to commence a calibration operation (e.g., in connection with trigger events such as the start of a new print job that is received, or identification of a printer component error, or a web media roll change), the web media continues to be moved through the printer during such trigger events. Non-production frames, for calibrating the printer and for use in directing a non-printing device downstream of the printer relative to workflow, are printed upon the media that is kept moving through the printer.

In a certain example of the disclosure, a system for printer calibration utilizing non-production frames is to receive a print job for printing upon a web media at a printer. The print job includes a set of production frames 1-n. The system is to cause printing of the production frames 1-n, a non-production frame x and a nonproduction frame y. The system is to cause the printer to print the non-production frame x and the non-production frame y after the printing of production frame 1 and before the printing of production frame n.

Continuing with this example, the system is to cause the non-production frame x to be printed with an instruction that is for scanning and interpretation at a non-printing apparatus downstream of the printer. The non-printing apparatus is to perform an action (e.g., a cutting, folding, and/or sorting action) upon the print job in accordance with the instruction included within the non-production frame x.

Continuing with this example, the system is to cause the non-production frame y to be printed to include a diagnostic pattern that is for scanning at the printer. The scanning is to generate scan data, e.g., data relative to registration and/or color attributes of the diagnostic pattern. The system is to in turn utilize the scan data to perform a calibration operation (e.g., an image alignment or color accuracy calibration) at the printer.

In a particular example of the disclosure, the printer is a multi-roll printer capable of switching from a first media roll to a second media roll without interrupting production printing of a print job. In this example the system for printer calibration utilizing non-production frames is to cause a splicing component upstream of the print application component (e.g., the printheads) of the printer, to perform a splicing operation that joins the first and second media rolls at a splice line. In this example, the system is to cause the printer to print the production frames 1-n, and the non-production frames x and y, such that such that no portion of the production frames 1-n nor the non-production frames x or y are printed over the splice line. The system not allowing printing upon the splice line avoids waste as in many applications the printing of the production frames 1-n or the non-production frames x or y the at the splice line would result in a printed job with unacceptable quality. In some applications the unacceptable quality might be a result of printout of one or more of production images 1-n being of poor quality. In other applications the unacceptable quality might be due to the downstream non-printing apparatus having incorrectly performing a cutting, folding, sorting, or other post-printing operation due to non-production frame y being printed over a splice such that included instruction is misinterpreted when read by a scanner at the non-printing apparatus.

In this manner, the disclosed method and system for printer calibration utilizing non-production frames enables printing of a print job without stopping production printing to perform calibration routines and then restarting production printing. The disclosed method and system will drastically shorten time to calibrate upon trigger events such as the printer switching medias, job types, ink densities, colors, tensions, or undergoing other changes in printing variables. Users and providers of printer systems will appreciate the supplies waste reductions and reductions in production printing downtime afforded by the disclosed examples. Users and providers of inkjet printer systems will further appreciate the improvements in print quality that will result from the disclosed examples. Installations and utilization of printers that include the disclosed method and system should thereby be enhanced.

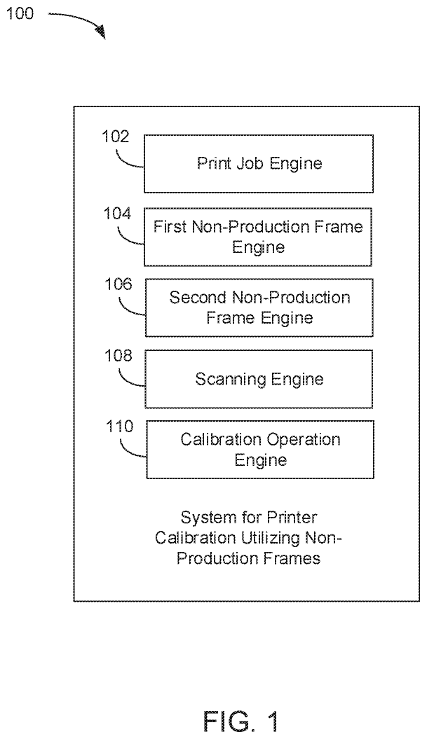

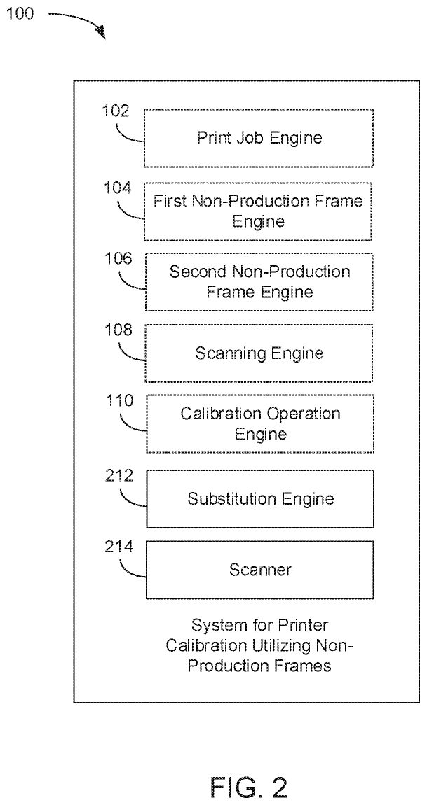

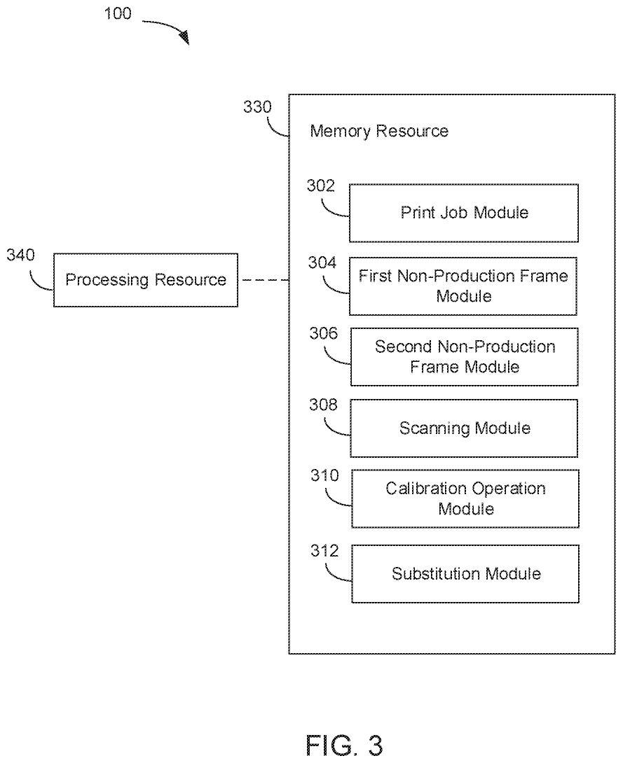

FIGS. 1 and 2 depict examples of physical and logical components for implementing various examples. In FIGS. 1 and 2 various components are identified as engines 102, 104, 106, 108, 110, and 212. In describing engines 102-110 and 212 focus is on each engine's designated function. However, the term engine, as used herein, refers generally to hardware and/or programming to perform a designated function. As is illustrated with respect to FIG. 3, the hardware of each engine, for example, may include one or both of a processor and a memory, while the programming may be code stored on that memory and executable by the processor to perform the designated function.

FIG. 1 is a block diagram depicting an example of a system 100 for printer calibration utilizing non-production frames. In this example, system 100 includes a print job engine 102, representing generally a combination of hardware and programming to cause a printer to print a job upon a roll media, the job including a plurality of production frames 1-n. As used herein, “printer” and “printing device” are used synonymously, and refer generally to any electronic device or group of electronic devices that consume a marking agent to produce a printed print job or printed content. In examples, a printer may be, but is not limited to, a liquid inkjet printer, a liquid toner-based printer, a LEP printer that utilizes electrostatic printing fluid and a blanket, or a dry toner printing device. The term “printer” includes a multifunctional device that performs a function such as scanning and/or copying in addition to printing. As used herein, a “job” and “print job” refers generally to content, e.g., an image, and/or instructions as to formatting and presentation of the content sent to a computer system for printing. In examples, a print job may be stored in a programming language and/or a numerical form so that the job can be stored and used in computing devices, servers, printers and other machines capable of performing calculations and manipulating data. As used herein, an “image” refers generally to a rendering of an object, scene, person, or abstraction such text or a geometric shape.

As used herein, a “print media”, or sometimes “media”, refers generally to an article or object on which a printed image can be formed. “Roll media”, “roll”, “web media”, and “web” are used synonymously and refer generally to a media that is to pass through a printer as a continuous length. Typically, a roll media is fed from a feeding reel at one end of the printer, through a print zone. In examples, after application of marking agent, the roll media may be wound upon a take-up reel at the opposite end of the printer. In examples, certain pre-printing events (e.g., application of primer) and/or post-print processing events (e.g., drying, application of overcoats, etc.) may occur at the printer, in addition to application of marking agent, to affect the roll media before its collection at the take-up reel. In examples, a set of rollers may be included within a printer to transport roll media from the supply reel, through the printer to pass a print zone, and out of the printer to be collected upon the take-up reel. In examples, a roller from the set of rollers may be formed from a plastic, a rubber-based substance, a metal, or any other durable material formed in a cylindrical shape with a smooth surface for interfacing with the roll media. In another example where a non-printing apparatus is situated downstream and in-line with the printer for purposes of performing a finishing operation on the roll media (e.g. a cutting, folding, stapling, and/or sorting operation), the printer would not utilize a take-up reel.

As used herein, a “frame” refers generally to a specified length or incidence of the roll media. In examples, a frame may be a “production frame”, a “non-production frame”, or a blank frame. As used herein, a “production frame” refers generally to a length or incidence of the roll media upon which an image from the print job is to be printed, wherein all or a portion of that frame is, or is to be incorporated in a finished product. Examples of production frames include, but are not limited to, frames that will be printed for use, reading, consumption, or enjoyment by an end user such as packaging labels, direct mail circulars, financial or account statements, pages of a book or magazine, and photographs. It should be noted that a frame that includes an image from the print job that is to be incorporated in a finished product is a “production frame” notwithstanding the inclusion of instructions (e.g., calibration marks, or coded instructions contained in the margins of the frame that are to trimmed away) for affecting a setting of the printer, or of an apparatus downstream of the printer. As discussed below, a “non-production frame” does not include an image from the print job that is to be incorporated in a finished product.

Continuing at FIG. 1, first non-production frame engine 104 represents generally a combination of hardware and programming to cause printing of a non-production frame x after the printing of production frame 1 and before the printing of production frame n. As used herein, a “non-production frame” refers generally to a length or incidence of the roll media that, in contrast to a production frame, does not include an image from the print job that is to be incorporated in a finished product, and that is not a blank frame. The non-production frame x is to include an instruction to be scanned by an apparatus downstream from the printer, the apparatus to perform a non-printing operation upon the printed print job. The instruction is to, after the scanning by the downstream apparatus, modify operations of, or cause a change in a setting of, the non-printing apparatus. The non-production frame x is sometimes referred to herein as a NPDAF (“non-production downstream apparatus frame”), As used herein a “printing operation” refers generally to a print job receipt operation, a primer application operation, a marketing agent application operation, a drying operation, an overcoat application, a duplexing operation, a printer calibration operation, or any other process taking place at the printer that is to create, or set up the printer to create, a printed print job on a media. As used herein a “non-printing operation” refers generally to any operation that is not a printing operation, including post-printing operations conducted at an apparatus other than the printer.

In certain examples, the non-printing apparatus that is to perform the non-printing operation is downstream in terms of workflow, but separate from the printer that is forming the production and non-production frames. In an example, after the printing of the production and non-production frames the printed upon roll media may be collected by a take-up reel, and the take-up reel transported to the non-printing apparatus. The downstream non-printing apparatus, now loaded with the roll media, would scan the instruction and modify or change apparatus settings based upon the instructions included in the non-production frames. In examples, the downstream apparatus may be a cutter, folder, sorter, stapler, or other finishing device for printed materials.

In other certain examples, the non-printing apparatus is downstream in terms of workflow and in-line with the printer. As used herein, “in-line” refers generally to the non-printing apparatus being placed within a line or sequence of the printer. In certain examples where the non-printing apparatus in in-line with the printer the printer, the non-printing apparatus shares the media path of the printer and the printer does include a take-up reel for collection of printed upon roll media.

Continuing at FIG. 1, in examples the instruction that is included within the NPDAF is to be scanned by a scanner (that is included within the non-printing apparatus that is to perform an action upon the printed job). As used herein, “scanner” refers generally to an electromechanical device that is to capture an image of a subject and convert that subject into digital form for storage or processing. In examples, the scanner is an optical sensor included within the downstream apparatus, and situated in the media path, such that the NPDAF can be interpreted by the non-printing apparatus and the settings of the non-printing apparatus can be modified or adjusted according to the instructions.

In examples, the instruction included within the NPDAF, to be scanned by a scanner at the downstream apparatus to modify operation of the non-printing apparatus, is a non-coded instruction that could be read and understood by a human user as well as by the non-printing apparatus. In other examples, the instruction included within NPDAF is a coded instruction that is not to be read and understood by a human user, e.g., an operator of the printer.

In examples, the coded instruction may a customer-defined instruction for the non-printing apparatus that is to inform the non-printing apparatus of an attribute of a subject production frame, such that the non-printing apparatus can perform a post-printing action upon the subject production frame. In other examples, the coded instruction may be a customer-defined instruction for the non-printing apparatus that is to inform the non-printing apparatus of an attribute of a set of production frames, the instruction for guiding the non-printing apparatus in finishing operations.

In a particular example, the non-printing apparatus may be a cutting apparatus, and the post-printing action is a cutting action with respect to the subject production frame. In this particular example, the instruction may be, after scanning at the downstream apparatus, to guide the non-printing apparatus in performing a sequence of cuts upon the printed-upon roll media to create sheets (e.g., pages of a book or magazine, photographs, direct mail literature).

Continuing at FIG. 1, second non-production frame engine 106 represents generally a combination of hardware and programming to cause printing of a non-production frame y after the printing of production frame 1 and before the printing of production frame n, the non-production frame y including a calibration image. The non-production frame y is sometimes referred to herein as a NPPCF (“non-production printer calibration frame”).

In one example, second non-production frame engine 106 is to cause printing of the NPPCF in response to receipt of a message or other data indicative that the non-printing apparatus downstream of the printer is malfunctioning. In another example, second non-production frame engine 106 is to cause printing of the NPPCF in response to receipt of a message or other data indicative that a component of the that printer downstream of a printhead is malfunctioning. In examples, the downstream component may be or include, but is not limited to, a duplexing apparatus, a drying unit, or a roll media-take up assembly). In yet another example, second non-production frame engine 106 is to cause printing of the NPPCF during a set-up operation for the printer. In each of these examples, system 100 enables a calibration routine to be performed for the printer while roll media advances continuously through the printer (e.g., while the printer or downstream apparatus malfunction is remedied or the printer setup is complete), thereby reducing waste of media that might otherwise occur

As used herein, “diagnostic”, “diagnostic image”, and “calibration image” are used synonymously and refer to an image that includes a target, or set of targets, or a pattern of targets that are to be placed in the focal plane of a sensor for measurement. In examples, the target may be a reference point for measuring color characteristics of a printed image, e.g., optical density, hue, saturation, lightness, gloss). In examples, the target may be or include a rectangle, oval, line segment, dot, spot, cross, or any other geometrical shape or other visual feature that can serve as fiducials for assessing correctness of printed image registration. In examples the calibration image may include multiple targets for assessing color characteristics. In examples the calibration image may include multiple targets for assessing correctness of image registration. In examples the calibration image may include a target for assessing color characteristics and a target for assessing correctness of image registration. In examples the calibration image may include a target that is for both assessing color characteristics and assessing correctness of image registration.

Continuing at FIG. 1, scanning engine 108 represents generally a combination of hardware and programming to cause a scanner, e.g. scanner 214 (FIG. 2), to scan image of the calibration image. In examples, scanner 214 is an optical sensor positioned at the printer and adjacent to the media path so as to face the roll media. Scanning engine 108 is to cause scanner 214 to optically capture the calibration image and create scan data representative of the calibration image. In examples the scan data includes measurements of the registration and/or color attributes of the calibration image.

Calibration operation engine 110 represents generally a combination of hardware and programming to perform a calibration operation at the printer based upon the scan data. As used herein “calibration operation” refers generally to a comparison of a measured value with a standard of known accuracy or a target value.

In examples, the calibration operation may be or include an image registration calibration. In examples, the image registration calibration may be for cross-web registration (e.g., front to back of media). In examples, the image registration calibration may be for cross-web registration (e.g., front to back of the roll media). In examples, the image registration calibration may be for down-web registration (e.g., one side of the roll media).

In examples, the calibration operation may be or include a color accuracy calibration operation. The color accuracy calibration operations may include, but are not limited to, color to color density (e.g., front to back of media), color to target color density (e.g., a camera or sensor calibration target), and color to color registration (print bar to print bar) calibrations. The color accuracy calibration may alternatively, or additionally, include optical density, hue, saturation, lightness, gloss, or other color attribute calibrations.

In examples, calibration operation engine 110 is to cause a change in a printer setting based upon the results of the calibration operation. For instance, in response to calibration operation results indicating an error in image registration calibration operation engine may cause an adjustment in the marking agent application system (e.g., in an inkjet printer, adjusting the position or firing of printheads). In another example, in response to calibration operation results indicating an error in image registration calibration operation engine 110 may cause an adjustment in media tension. In another example, in response to calibration operation results indicating an error in image registration, calibration operation engine 110 may cause sending of a user message indicative that a user maintenance intervention is needed (e.g., in the case of an inkjet printer, to service a printhead).

Likewise, in response to calibration operation results indicating an error in color accuracy, calibration operation engine may cause an adjustment in the marking agent application system (e.g., in an inkjet printer, adjusting the position or firing of printheads, adjusting the mix of colored marking agents applied), cause an adjustment in other printer systems (e.g., drying time or drying temperature), or cause sending of a user message indicative that a user maintenance intervention is needed.

Continuing at FIG. 1 and returning to the description of first non-production frame engine 104, it should be noted that in certain examples the instruction that is included within the NPDAF may include a calibration image. The calibration image included within the NPDAF is for calibrating the non-printing apparatus that is downstream of the printer. The instruction with the calibration image is to cause a calibration operation at the downstream apparatus, and to cause a change in a setting of the non-printing apparatus in response to the calibration operation. In examples wherein the printer is an inkjet printer, the change in setting may be or include, but is not limited to, a change in position or firing of printheads, sending of a user message indicative that a user maintenance intervention is needed, a change in media tension, and/or a change in drying parameters.

FIG. 2 is a block diagram depicting another example of a system for printer calibration utilizing non-production frames. In this example system 100 includes, in addition to components 102-110 discussed with respect to FIG. 1, a substitution engine 212 and a scanner 214. Substitution engine 212 represents generally a combination of hardware and programming to, in an example where first non-production frame engine 104 is to cause printing of a set of NPDAFs, cause printing of a second NPPCF in substitution of one from the set of NPDAFs. In this example, the second NPPCF is to be scanned by scanner 214 and utilized in a new or additional calibration operation for the printer. In certain examples, substitution engine 212 will cause the substitution of a NPPCF for a NPDAF due to an urgent need for a calibration operation at the printer. In examples, substitution engine 212 may cause later printing of the NPDAF that was substituted for, such the scanner at the downstream device will still scan all the NPDAFs expected for guiding operation of the downstream device. This substitution capability afforded by substitution engine 212 can be particularly useful where the downstream device is not in-line with the printer.

In the foregoing discussion of FIGS. 1 and 2, print job engine 102, first non-production frame engine 104, second non-production frame engine 106, scanning engine 108, calibration operation engine 110, and substitution engine 212 were described as combinations of hardware and programming. Engines 102-110 and 212 may be implemented in a number of fashions. Looking at FIG. 3 the programming may be processor executable instructions stored on a tangible memory resource 330 and the hardware may include a processing resource 340 for executing those instructions. Thus, memory resource 330 can be said to store program instructions that when executed by processing resource 340 implement system 100 of FIGS. 1 and 2.

Memory resource 330 represents generally any number of memory components capable of storing instructions that can be executed by processing resource 340. Memory resource 330 is non-transitory in the sense that it does not encompass a transitory signal but instead is made up of a memory component or memory components to store the instructions. Memory resource 330 may be implemented in a single device or distributed across devices. Likewise, processing resource 340 represents any number of processors capable of executing instructions stored by memory resource 330. Processing resource 340 may be integrated in a single device or distributed across devices. Further, memory resource 330 may be fully or partially integrated in the same device as processing resource 340, or it may be separate but accessible to that device and processing resource 340.

In one example, the program instructions can be part of an installation package that when installed can be executed by processing resource 340 to implement system 100. In this case, memory resource 330 may be a portable medium such as a CD, DVD, or flash drive or a memory maintained by a server from which the installation package can be downloaded and installed. In another example, the program instructions may be part of an application or applications already installed. Here, memory resource 330 can include integrated memory such as a hard drive, solid state drive, or the like.

In FIG. 3, the executable program instructions stored in memory resource 330 are depicted as print job module 302, first non-production frame module 304, second non-production frame module 306, scanning module 308, calibration operation module 310, and substitution module 312. Print job module 302 represents program instructions that when executed by processing resource 340 may perform any of the functionalities described above in relation to print job engine 102 of FIG. 1. First non-production frame module 304 represents program instructions that when executed by processing resource 340 may perform any of the functionalities described above in relation to first non-production frame engine 104 of FIG. 1. Second non-production frame module 306 represents program instructions that when executed by processing resource 340 may perform any of the functionalities described above in relation to second non-production frame engine 106 of FIG. 1, Scanning module 308 represents program instructions that when executed by processing resource 340 may perform any of the functionalities described above in relation to scanning engine 108 of FIG. 1. Calibration operation module 310 represents program instructions that when executed by processing resource 340 may perform any of the functionalities described above in relation to calibration operation engine 110 of FIG. 1. Substitution module 312 represents program instructions that when executed by processing resource 340 may perform any of the functionalities described above in relation to substitution engine 212 of FIG. 2.

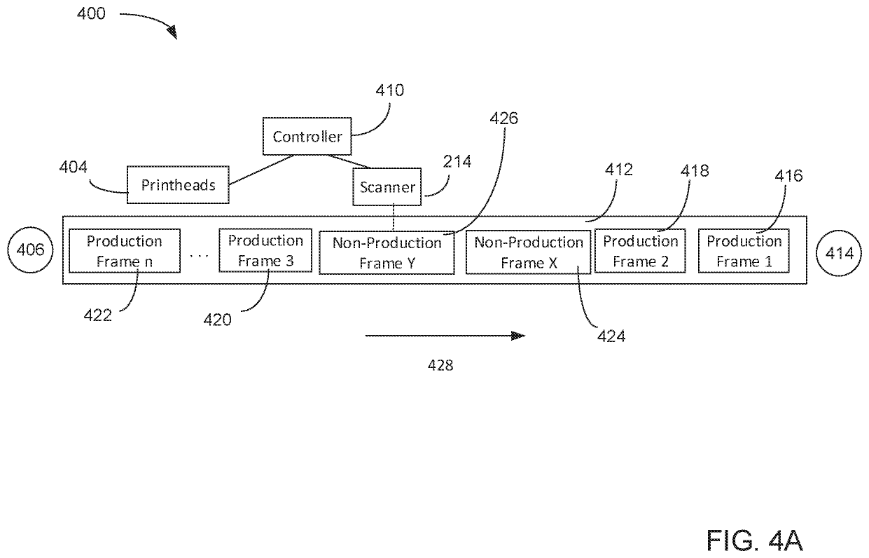

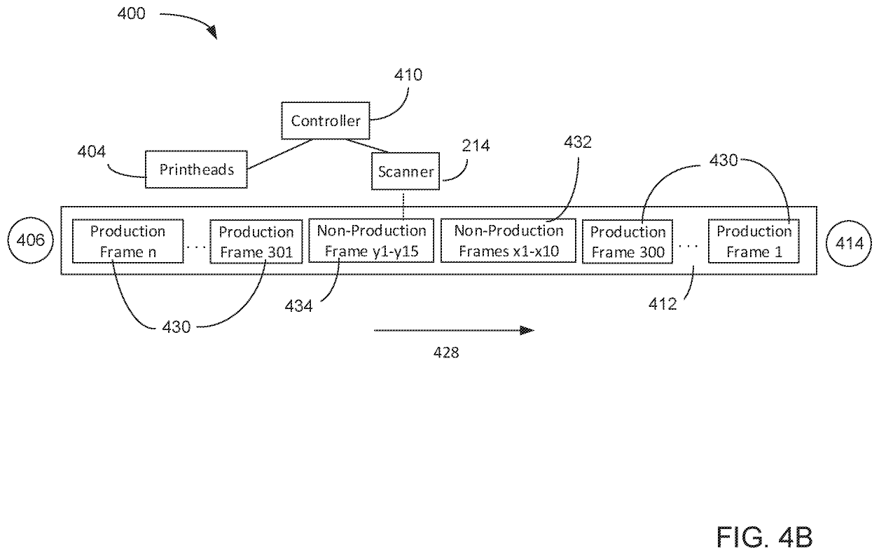

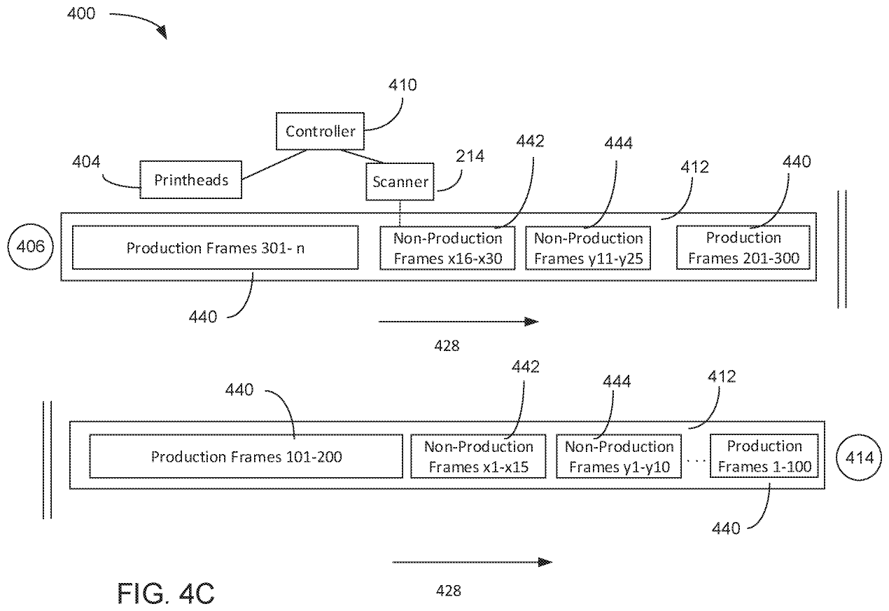

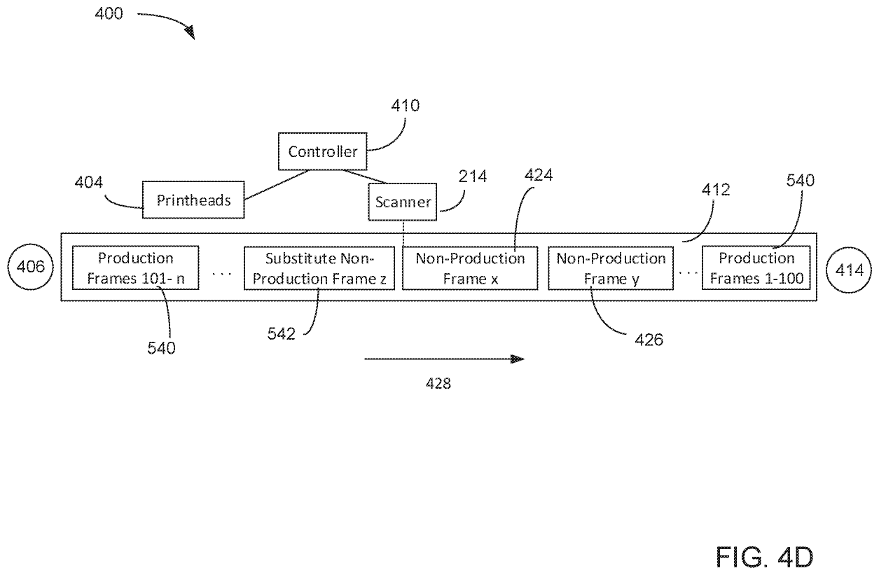

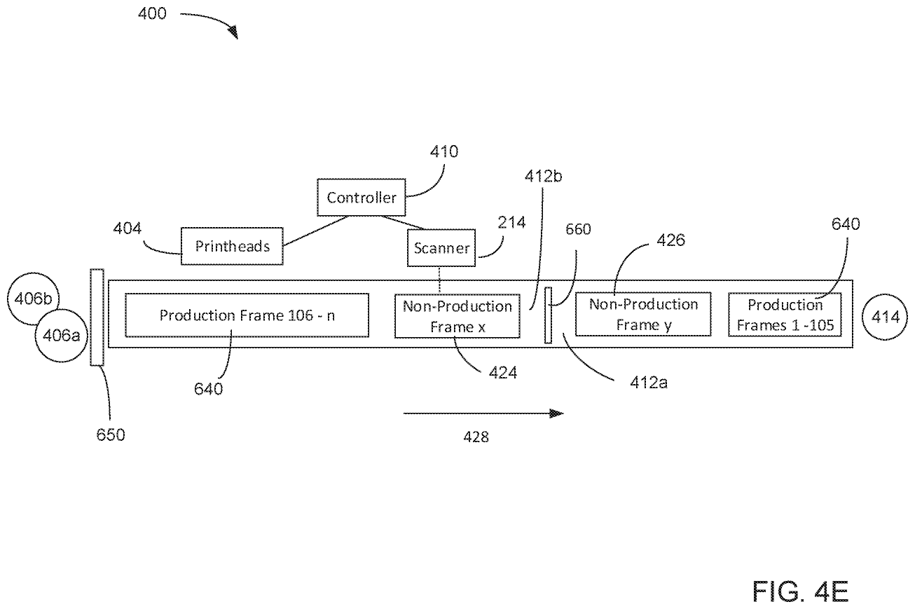

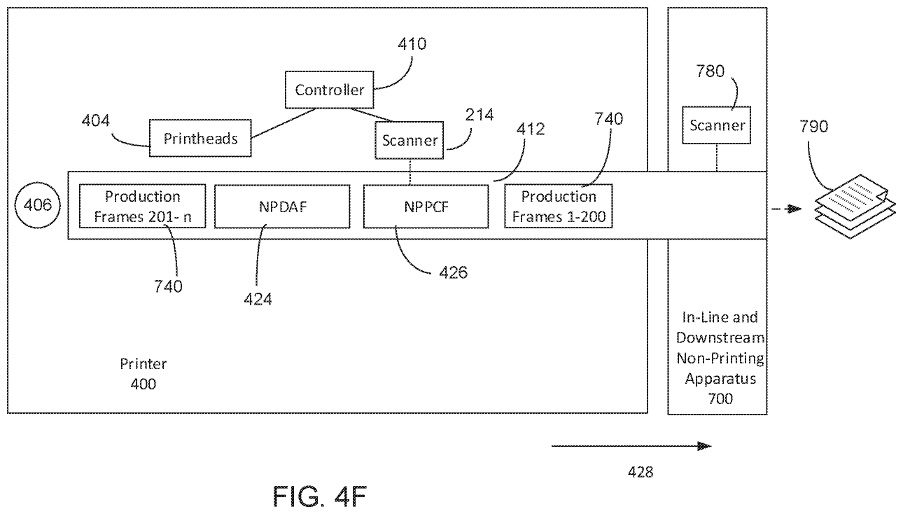

FIGS. 4A-4F are simple schematic diagrams that illustrate examples of a system 100 for printer calibration utilizing non-production frames. In the examples of each of FIGS. 4A-4F, a printer 400 includes a set of printheads 404, a scanner 214, a supply reel media transport component 408, and a controller 410. Printheads 404 are to eject marking agent form images upon a roll media 412 in accordance with a print job at printer 400. In examples, printheads 404 may be thermal inkjet printheads or piezo printheads. Supply reel media transport component 406, in conjunction with rollers not depicted in FIGS. 4A-4F, is a component to cause movement of roll media 406 in a roll media direction 428 past the set of printheads during a printing operation. In the examples of FIGS. 4A-4E, printer 400 additionally includes a take-up reel media transport component 414 for collection of roll media 412 that has passed through printer 400 during printing operations. In the examples of FIG. 4F, printer 400 does not include a take-up reel as a non-printing device 700 that is in-line with and downstream printer 400 is to perform a finishing operation (e.g., cutting, sorting, stapling, and/or folding) after the marking agent application process is completed. Scanner 214 is an optical sensor positioned at the printer and adjacent to roll media 412 to face the roll media. Controller 410 is a combination of hardware and programming that is to manage a calibration of printer 400 utilizing non-production frames.

In the example of FIG. 4A, controller 410 is to receive a print job that includes a production frame 1 416, production frame 2 418, production frame 3 420, and production frame n 422. Controller 410 is to cause printheads 404 to print production frame 1 416, production frame 2 418, production frame 3 420, and production frame n 422.

Continuing at FIG. 4A, controller 410 is also to cause printheads 404 to print a non-production frame x 424 and a nonproduction frame y 426. Non-production frame x 424 includes an instruction for modification of a non-printing apparatus (not shown in FIG. 4A) that is to perform an action upon the printed print job. The instruction is to be read at a scanner at the non-printing apparatus, so as to cause the modification of the non-printing apparatus. In examples, the modification of the non-printing apparatus may change in settings of the non-printing apparatus to act upon the printed job (e.g., settings for a cutting, folding, stapling, or sorting action to be taken by the non-printing apparatus). In other examples, the instruction included non-production frame 424 may include a diagnostic or calibration pattern, and the modification of the non-printing apparatus may be a change in settings based upon a calibration operation at the non-printing apparatus that utilizes the diagnostic or calibration pattern.

Continuing at FIG. 4A, nonproduction frame y 426 that is printed upon roll media 412 includes a diagnostic. In this example non-production frame y 426 is printed after the printing of production frame 1 416 and production frame 2 418, and before the printing of production frames 3-n 420 422. Controller 410 causes scanner 214 to scan the diagnostic included non-production frame y to generate scan data. Controller 214 in turn causes print 400 to perform a calibration of a printhead of the set of printheads 404 based upon the scan data. The printing of non-production frames x and y, and the printer calibration operation as production printing operations are suspended and without movement of the roll media 412 stopping.

In a particular example, controller 410 triggers printing of non-production frame x 424 and non-production frame y 426, and the printer calibration operation utilizing the diagnostic within non-production frame y 426, in response to receipt of data that a printer setup event is to occur. In another example, controller 410 triggers printing of non-production frame x 424 and non-production frame y 426, and the printer calibration operation utilizing the diagnostic within non-production frame y 426, in response to receipt of data indicative that a printer component of the printer downstream of printheads 404 (e.g., a duplexer, a dryer, or an overcoat applicator) is malfunctioning or has malfunctioned. In another example, controller 410 triggers printing of non-production frame x 424 and non-production frame y 426, and the printer calibration operation utilizing the diagnostic within non-production frame y 426, in response to receipt of data indicative that the non-printing apparatus downstream of printer 400 is malfunctioning or has malfunctioned. In examples, the data is indicative of malfunction of non-printing apparatus that is in-line with printer 400. In other examples, the data is indicative of malfunction of a non-printing apparatus that is downstream in terms of workflow relative to printer 400, yet not in-line with printer 400.

Moving to FIG. 4B, in this example controller 410 is to receive a print job that includes a set of production frames 1 through n 430. Controller 410 is to cause printheads 404 to print production frames 1-n 430, non-production frames x1-x10 432, and non-production frames y1-y15 434. Non-production frames x1-x10 432 include instructions for modification of a non-printing apparatus (not shown in FIG. 4B) that is to perform an action upon the printed print job (e.g. production frames 1-n). This example makes it clear that controller 410 may cause printing of multiple non-production frame x's (NPDAFs) and multiple non-production frame y's (NPPCFs) for a single print job.

Moving to FIG. 4C, in this example controller 410 is to receive a print job that includes a set of production frames 1 through n 440. Controller 410 is to cause printheads 404 to print production frames 1-n 440, non-production frames x1-x30 442, and non-production frames y1-y25 444. Non-production frames x1-x30 442 include instructions for modification of a non-printing apparatus (not shown in FIG. 4B) that is to perform an action upon the printed print job (e.g. production frames 1-n). The example of FIG. 4C makes it clear that controller 410 may cause printing of the multiple non-production frame x's (NPDAFs) and the multiple non-production frame y's (NPPCFs) in portions (i.e., it is not required that all NPDAFs for a print job be printed consecutively, or that all NPPCFs for a print job be printed consecutively. Further, FIG. 4C illustrates that in some examples controller 410 will cause printing of the non-production y frames (NPPCFs) (see e.g., non-production frames y1-y10) before causing printing of the non-production frame x frames (NPDAFs) (see e.g., non-production frames x1-x15). In other examples (see, e.g., FIG. 4B), controller 410 is to cause printing of non-production frame x frames (NPDAFs) before causing printing of the non-production y frames (NPPCFs).

Moving to FIG. 4D, in this example controller 410 is to receive a print job that includes a set of production frames 1 through n 540. Controller 410 is to cause printheads 404 to print production frames 1-n 540, a non-production frame x 424 (NPDAF type) and a non-production frame y 426 (NPPCF type). In this example, in response to receipt of data indicative that printing of a NPPCF type frame for printer calibration is urgent, or is a priority as the need for a NPPCF type frame outweighs a planned printing of a NPDAF type non-production frame z, controller 410 causes printing of substitute non-production frame z 542 (NPPCF type) instead of a non-production frame z (NPDAF type) that was to be printed absent controller's receipt of the data indicating an urgency or priority for the NPPCF type frame.

Moving to FIG. 4E, in this example printer 400 is a multi-roll printer. In this example printer 400 has a first supply reel 406a and a second supply reel 406b. Controller 410 causes printer 400 to switch from printing on a first media roll 412a fed from first supply reel 406a to printing on a second media roll 412 b fed from second supply reel 406b. This switch from printing on first media roll 412a to printing on second media roll 412b takes place as a result of a splicing mechanism 650 that is upstream of printheads 404 performing a splicing operation that joins the first media roll 412a and second media roll 412b at a splice line 660, Controller 410 causes printer 400 to print NPDAF frames (in FIG. 4E, non-production frames x) and NPPCF frames (in FIG. 4E, non-production frame y) such that no portion of the production frames 1-n 640 nor the non-production frames x 424 or y 426 are printed over splice line 660.

FIG. 4F illustrates another example of a system for printer calibration utilizing non-production frames. In this example, controller 410 is to receive a print job that includes a production frames 1-n 740. Controller 410 is to cause printheads 404 to print production frames 1-n, a NPDAF frame 424 and a NPPCF frame 426. NPDAF 424 includes an instruction for modification of a non-printing apparatus 700 (in-line with and downstream relative to printer 400) that is to perform an action upon the received print job after the job is printed. In examples, non-printing apparatus 700 may be to perform cutting, folding, stapling, sorting, and/or other post-printing actions upon the job printed by printer 400, and thereby produce a finished job 790. The instruction is to be read by a scanner 780 at non-printing apparatus 700, so as to cause a modification or change in a setting of non-printing apparatus 700. In certain examples, the modification or change in settings of the non-printing apparatus is to enable non-printing apparatus 700 to set knives, blades, turn rollers, stackers, sorters, etc. to positions to handle post-printing actions on the printed job to produce finished job 790. In examples finished job 790 may be, but are is not limited to, cut pages for a magazine or newspaper, cut coupons, or folded and stapled direct mailing materials. In other examples, the instruction included in non-production frame 424 includes a diagnostic or calibration pattern, and the modification of the non-printing apparatus may be in response to a calibration operation at non-printing apparatus 700.

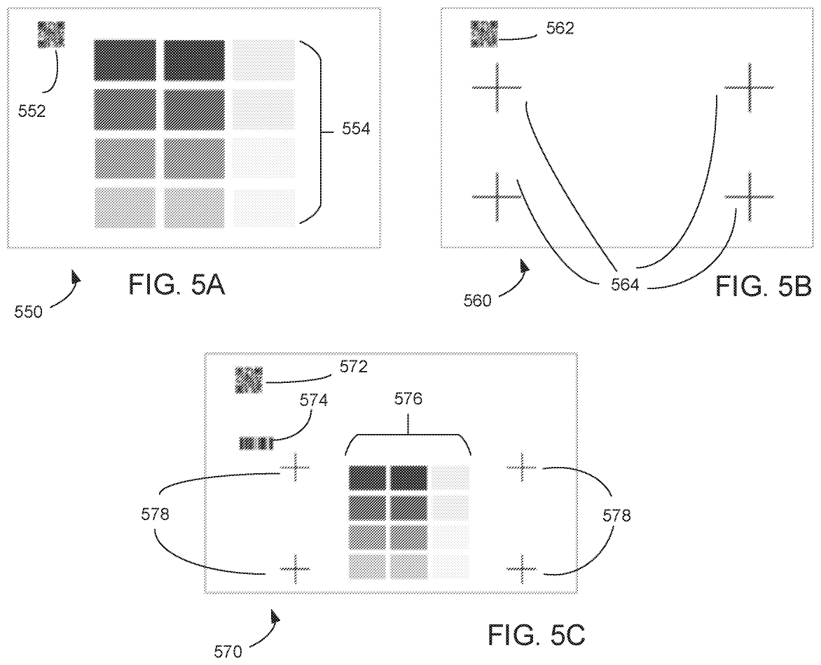

FIGS. 5A-5C are simple schematic diagrams that illustrate examples of a non-production frame x (type NPDAF) having an instruction for modification of a non-printing apparatus. FIG. 5A illustrates a NPDAF 550 that includes a machine-readable code 552 and set of color calibration tiles 554. Machine readable code 552 is to be read by a scanner (e.g. scanner 780, FIG. 4F) to inform a downstream non-printing apparatus (e.g., non-printing apparatus 700, FIG. 4F) that the current frame is a non-production frame including color calibration tiles 554 for performing a color accuracy calibration at the non-printing apparatus. As used herein a “machine readable code” may be or include, but is not limited to, a QR code or a bar code. In examples, the color accuracy calibration may be to ensure the printer produces a color that is sufficiently similar to a target, e.g., a Pantone. In other examples, the color accuracy calibration may be to ensure the printer prints colors sufficiently similar to the colors printed by the printer in a prior print job. In yet another example, the color accuracy calibration may be to ensure the printer is printing colors sufficiently similar to the colors that are being printed by another printer. In other examples, a user at a downstream non-printing device might pull NPDAF 550 from the press for visual inspection or to utilize and offline spectrophotometer or other sensor or scanner to verify the press is printing colors correctly.

FIG. 5B illustrates a NPDAF 560 that includes a machine-readable code 562 and set of alignment fiducials 564. Machine readable code 562 is to be read by a scanner (e.g. scanner 780, FIG. 4F) to inform a downstream non-printing apparatus (e.g., non-printing apparatus 700, FIG. 4F) that the current frame is a non-production frame including alignment fiducials for 564 for performing an event (e.g. a cutting, folding, or stapling event) at the non-printing apparatus. As used herein, a “fiducial” refers generally to a geometrical shape or other visual feature that may be placed in the focal plane of a sensor or scanner and used as a reference point for measuring a distance. In this particular example, the fiducials are cross shaped, but in other examples fiducials may be, but are not limited to, a rectangle, oval, line segment, dot, or spot shape fiducial.

FIG. 5C illustrates a NPDAF 570 that includes a first machine-readable code 572, a second machine-readable code 574, a set of color calibration fiducials 576 and a set of alignment fiducials 578. First machine readable code 572 is to be read by a scanner (e.g. scanner 780, FIG. 4F) to inform a downstream non-printing apparatus (e.g., non-printing apparatus 700, FIG. 4F) that the current frame is a non-production frame including color calibration fiducials 576 and alignment fiducials for 578 for aligning a print job such that the non-printing apparatus can perform a cutting, sorting, stapling, or other post-print action upon the print job. In this example, second machine readable code 574 is to be read by a scanner at a downstream non-printing apparatus to inform the non-printing apparatus that the current frame is a non-production frame including color calibration fiducials 576 and image registration fiducials for 578 for performing an image registration event at the non-printing apparatus.

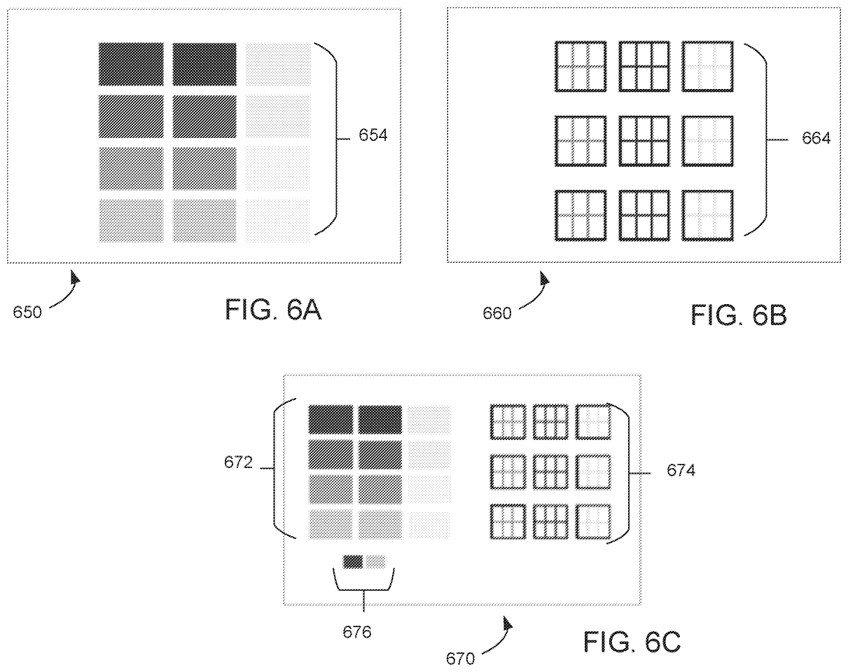

FIGS. 6A-6C are simple schematic diagrams that illustrate examples of non-production frames y (type NPPCF) having a diagnostic, the diagnostic scannable to generate scan data for use in a printer calibration operation. FIG. 6A illustrates a NPPCF 650 that includes a diagnostic with a set of color calibration tiles 654. Color calibration tiles 654, when read by a scanner (e.g., scanner 214 of any of FIG. 2 or FIG. 4A-4F at a printer (e.g. printer 400 of any of FIGS. 4A-4F) are to cause the printer to adjust color settings at the printer.

FIG. 6B illustrates a NPPCF 660 includes a diagnostic with set of image alignment fiducials 664, that when read by a scanner at the printer is to cause the printer to calibrate image alignment, e.g. how marking agent is applied to a substrate to precisely place a printed image upon the roll media.

FIG. 6C illustrates a NPPCF 670 that includes a diagnostic with set of color calibration tiles 672, a set of image alignment fiducials 674, and a set of front-to-back image alignment fiducials 676. Color calibration tiles 672 when read by the scanner at the printer are to cause the printer to adjust color settings at the printer. Set of image alignment fiducials 674, when read by the scanner at the printer are to cause the printer to calibrate image alignment, e.g. how marking agent is applied to a substrate to precisely place a printed image upon a first side of the roll media). Set of front-to-back image alignment fiducials 676 when read by the scanner at the printer are to cause the printer to calibrate image alignment as between first and second sides of the roll media, e.g. where the printer is a duplex printer.

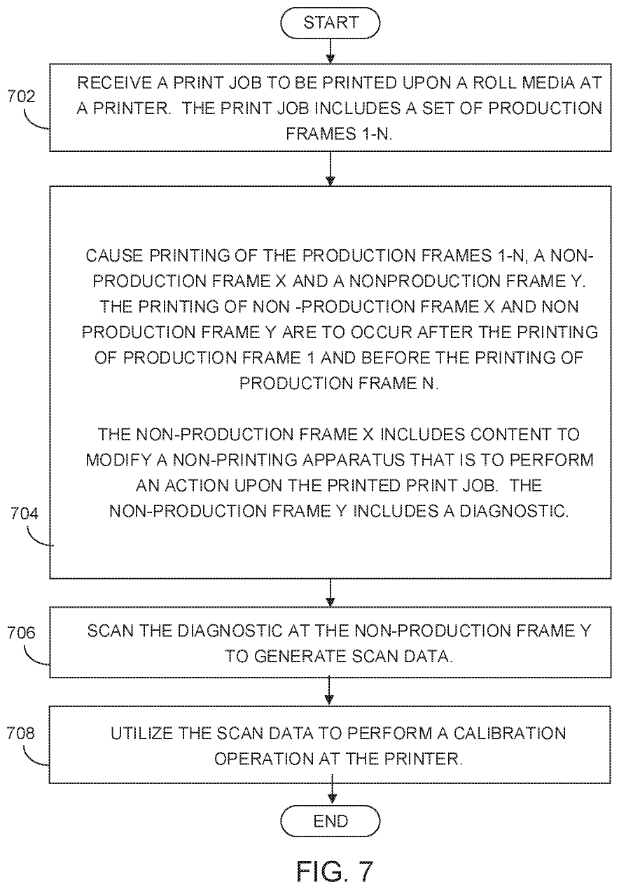

FIG. 7 is a flow diagram of implementation of a method for printer calibration utilizing non-production frames. A print job to be printed upon a roll media is received at a printer. The print job includes a set of production frames 1-n (block 702).

The production frames 1-n, a non-production frame x and a nonproduction frame y are caused to be printed. Non-production frame x and non-production frame y are printed after the printing of production frame 1 and before the printing of production frame n. Non-production frame x includes an instruction to modify a non-printing apparatus that is to perform an action upon the printed print job. Non-production frame y includes a diagnostic (block 704).

The diagnostic at the non-production frame y is scanned to generate scan data (block 706).

The scan data is utilized to perform a calibration operation at the printer (block 708).

FIGS. 1-7 aid in depicting the architecture, functionality, and operation of various examples. In particular, FIGS. 1-6 depict various physical and logical components. Various components are defined at least in part as programs or programming. Each such component, portion thereof, or various combinations thereof may represent in whole or in part a module, segment, or portion of code that comprises executable instructions to implement any specified logical function(s). Each component or various combinations thereof may represent a circuit or a number of interconnected circuits to implement the specified logical function(s). Examples can be realized in a memory resource for use by or in connection with a processing resource. A “processing resource” is an instruction execution system such as a computer/processor based system or an ASIC (Application Specific Integrated Circuit) or other system that can fetch or obtain instructions and data from computer-readable media and execute the instructions contained therein, A “memory resource” is a non-transitory storage media that can contain, store, or maintain programs and data for use by or in connection with the instruction execution system. The term “non-transitory” is used only to clarify that the term media, as used herein, does not encompass a signal. Thus, the memory resource can comprise a physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory (EPROM), flash drives, and portable compact discs.

Although the flow diagram of FIG. 7 shows specific orders of execution, the order of execution may differ from that which is depicted. For example, the order of execution of two or more blocks or arrows may be scrambled relative to the order shown. Also, two or more blocks shown in succession may be executed concurrently or with partial concurrence. Such variations are within the scope of the present disclosure.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein. All of the features disclosed in this specification (including any accompanying claims, abstract and drawings), and/or all of the blocks or stages of any method or process so disclosed, may be combined in any combination, except combinations where at least some of such features, blocks and/or stages are mutually exclusive. The terms “first”, “second”, “third” and so on in the claims merely distinguish different elements and, unless otherwise stated, are not to be specifically associated with a particular order or particular numbering of elements in the disclosure.

What is claimed is:

1. A method for printer calibration utilizing non-production frames, comprising:
receiving a print job to be printed upon a roll media at a printer, the print job including a plurality of production frames 1-n;
causing printing of the production frames, a non-production frame x and a nonproduction frame y, wherein
the non-production frame x includes an instruction to modify a non-printing apparatus that is to perform an action upon the printed print job, and the non-production frame x is printed after the printing of production frame 1 and before the printing of production frame n, and
the non-production frame y includes a diagnostic, and the non-production frame y is printed after the printing of production frame 1 and before the printing of production frame n;
scanning the diagnostic to generate scan data; and
utilizing the scan data to perform a calibration operation at the printer.

2. The method of claim 1, wherein the non-printing apparatus is downstream of the printing of the print job in terms of workflow.

3. The method of claim 1, wherein the printing of the non-production frame y is triggered by one from the set of 1) receipt of data indicative that the non-printing apparatus is malfunctioning, 2) receipt of data indicative that a component of the printer downstream of a printhead is malfunctioning, a set-up of the printer.

4. The method of claim 1, wherein the non-production frame x instruction is a coded instruction.

5. The method of claim 1, wherein scanning the diagnostic is performed utilizing a scanner at the printer.

6. The method of claim 1, wherein the calibration operation is an image registration calibration.

7. The method of claim 1, wherein the calibration operation is a color accuracy calibration.

8. The method of claim 1, wherein modifying the non-printing apparatus includes informing the apparatus of an attribute of a subject production frame among production frames 1-n, such that the apparatus can perform a post-printing action upon the subject production frame.

9. The method of claim 8, wherein the apparatus is a cutting apparatus, and wherein the post-printing action is a cutting action with respect to the subject production frame.

10. The method of claim 1, wherein the calibration operation is a first calibration operation and the diagnostic is a first diagnostic, and wherein modifying the non-printing apparatus includes providing a second diagnostic that is to be scanned and utilized in a second calibration operation that is for the non-printing apparatus.

11. The method of claim 1,
wherein the printer is a multi-roll printer;
further comprising causing the printer to switch from a first media roll to a second media roll, without interrupting printing of the print job, by performing a splicing operation that joins the first and second media rolls at a splice line; and
further comprising causing the printer to print the non-production frames x and y such that no portion of the production frames 1-n nor the non-production frames x or y are printed over the splice line.

12. A system for printer calibration utilizing non-production frames, comprising:
a print job engine, to cause a printer to print a job upon a roll media, the job including a plurality of production frames 1-n;
a first non-production frame engine, to cause printing of a non-production downstream apparatus frame (“NPDAF”) after the printing of production frame 1 and before the printing of production frame n, the NPDAF including an instruction to be scanned by an apparatus downstream from the printer, the apparatus to perform a non-printing operation upon the printed print job, and the instruction to, after the scanning, cause a change in a setting of the apparatus;
a second non-production frame engine, to cause printing of a non-production printer calibration frame (“NPPCF”) after the printing of production frame 1 and before the printing of production frame n, the NPPCF including a calibration image;
a scanner;
a scanning engine, to cause a scanner to capture the calibration image and create scan data representative of the calibration image; and
a calibration operation engine, to perform a calibration operation at the printer based upon the scan data.

13. The system of claim 12, wherein therein the apparatus is not in-line with the printer.

14. The system of claim 12,
wherein the calibration operation is a first calibration operation;
wherein the NPDAF is a first NPDAF, and the first non-production frame engine is to cause printing of a set of NPDAFs;
wherein the NPPCF is a first NPPCF; and
further comprising a substitution engine to cause printing of a second NPPCF in substitution of one from the set of NPDAFs to be printed.

15. A printer, comprising:
a set of printheads to form images upon a roll media in accordance with a received print job;
a media transport component to cause movement of the roll media past the set of printheads;
a scanner;
a controller to
receive the print job, the print job including a plurality of production frames 1-n;
cause the set of printheads to print of the production frames 1-n, a non-production frame x and a nonproduction frame y, wherein
the non-production frame x includes an instruction to modify a non-printing apparatus that is to perform an action upon the printed print job, and the non-production frame x is printed after the printing of production frame 1 and before the printing of production frame n, and
the non-production frame y includes a diagnostic, and the non-production frame y is printed after the printing of production frame 1 and before the printing of production frame n;
cause the scanner to scan the diagnostic at the non-production frame y to generate scan data; and
perform a calibration of a printhead of the set of printheads based upon the scan data, without stopping movement of the roll media during printing of the print job.
